(19) United States
(12) Patent Application Publication
(10) Pub. No.: US 2017/0232299 A1
(43) Pub. Date: Aug. 17, 2017

(54) Body Movement Tracking System

(71) Applicants: Marquette Trishaun, Orlando, FL (US); Laron A. Walker, Sandy Springs, GA (US)

(72) Inventors: Marquette Trishaun, Orlando, FL (US); Laron A. Walker, Sandy Springs, GA (US)

(21) Appl. No.: 15/431,401

(22) Filed: Feb. 13, 2017

Related U.S. Application Data
(60) Provisional application No. 62/295,018, filed on Feb. 13, 2016.

(51) Int. Cl. A63B 24/00; A41B 1/08; A41D 1/08; G01C 19/5776; A41D 1/00

(52) U.S. Cl. CPC A63B 24/0062; G01C 19/5776; A41D 1/002; A41D 1/08; A41B 1/08; H04L 67/306

(57) ABSTRACT

A body movement tracking system featuring an inertial measurement unit, processor, communication adapter, and a memory coupled to the processor configured to store program instructions that, when executed by the processor, cause the processor to capture, identify, and report data related to a dance.

### BACKGROUND OF THE INVENTION

The present subject matter relates generally to a body movement tracking system. More specifically, the present invention relates to a body movement tracker which utilizes multiple inertial measurement units (IMUs) to detect movement of specific areas of the body.

In recent years, there has been a large-scale adoption in the fitness industry of body movement trackers. Specifically, many of these trackers measure the number of steps walked in a day or the total distance traveled. To measure such movement, these trackers use what is known as an inertial measurement unit which is an electronic device that measures and reports a body's specific force, angular rate, and sometimes the magnetic field surrounding the body, using a combination of accelerometers and gyroscopes, and sometimes also magnetometers. Once such data is collected by the IMU of a movement tracker, algorithms are used within the tracker or on another computing device (e.g., smartphone, tablet, laptop, etc.) to approximate calories burned over a specific time interval, steps taken, etc.

Almost without exception, these trackers monitor overall body movement using an IMU with little to no information collected about what portions of the body are being moved nor what activity the body movement is associated with (e.g., dancing versus rowing, riding a bike versus climbing a ladder, etc.).

Accordingly, there is a need for a body movement tracking system which utilizes multiple IMUs to detect specific forms of body movement.

### BRIEF SUMMARY OF THE INVENTION

To meet the needs described above and others, the present disclosure provides a body movement tracking system which utilizes multiple IMUs and modules of code which identify and track movement of specific body parts.

In one embodiment of this invention, the body movement tracking system may feature one or more wearable devices (wearable sensor printed circuit boards (PCBs) in this example); each of these devices containing one or more IMUs. The wearable devices may also feature other electronic components including a heart rate monitor, a processor, a memory, a battery, a wireless networking communication antenna, and/or a wired communication plug. This embodiment also features one or more modules of code which analyze the data collected by the IMUs, heart rate sensor, etc., to determine the type of body movement which is occurring. These modules of code may be run on the wearable device(s) themselves (with a readout display potentially also being incorporated into the device for display of data to the end user) or run on any suitable computing device (e.g., smartphone, computer, tablet, medical diagnostic equipment, etc.). If the modules of code are run on a separate computing device, transmission of data from the wearable tracker to the computing device may be carried out by wireless (e.g., ZigBee, Wi-Fi, Bluetooth, RF, and/or ANT+ communication protocols) or wired connection (e.g., USB, Ethernet, Firewire, Lightning connection).

The module(s) of code mentioned above enable localized tracking and analysis of predetermined dance forms or other body movements by using support vector machines to compare user movement to a set of trained subspaces that are based on experts of the proposed motion and form. This software may also be designed to maximize battery life by placing the sensors in a low-power mode until body motion exceeds a movement threshold on the IMU sensor. When movement is detected which exceeds this threshold, the wearable device(s) shall begin collecting and reporting data over the established wired or wireless link between the wearable device and personal computing device with which the movement tracking device is in communication with. The software will also place the sensor back into sleep mode when physical activity ceases over a specified time interval to preserve battery life. It should be noted that modules of codes (software, algorithms, etc.) disclosed in this application may run in part or in whole on the movement tracking device and/or the computing device which the tracking device is in communication with. Additionally, all functions discussed can be intergraded into one device (for instance, a piece of smart clothing) as consumer demand dictates.

In this embodiment, a sensor software application running on the computing device (e.g., a mobile device) communicating with the tracker(s) shall compute the data from the tracker's sensors for analysis per the desired outputs as specified by the end user. The algorithm may compute heart rate, calories burned, angular and tangential acceleration, revolutions, amplitude and magnitude for use in analyzing a user's motions. The software suite allows for an instructor or user to compare their data against stored profiles of other practitioners.

The mobile device (or other computing device) sensor software application also provides multiple data points stored in an exportable form for upload to personal trainer work out tracking software, etc. These data points can also be transmitted in real time to an online portal for data analysis. The application may be downloaded through all major app store market places and over the internet using a personal computer.

Other embodiments of this invention exist including: a body movement tracking system in communication with a computing device featuring an inertial measurement unit, a processor, a communication adapter, and a memory coupled to the processor configured to store program instructions. When these instructions are executed, they cause the processor to capture data corresponding to speed and rhythm of a dance, compare an inertial measurement of the data with an initiation threshold, and if the inertial measurement exceeds the initiation threshold, automatically initiate transmission of the at least one data point through the communications adapter to the computing device. In this embodiment, the inertial measurement corresponds to an inertial measurement created by a specific body motion of a dance, such dances may include aerobic dance exercise, twerking, etc.

Yet other embodiments of this system may include a plurality of inertial movement units featuring an accelerometer and a gyroscope. All the embodiments detailed in this application may transmit data to an application on a computing device. The data received by one or more computing devices may be stored in a database which can then be examined by the system to identify the data as corresponding to a specific type of dance (e.g., twerking). The data can also be stored as part of a user profile which the system can maintain and monitor. If a user exceeds predefined alert thresholds based off the movement data the system receives, it may generate an alert message in the form of device notification, text message, email, etc.

A goal of this invention is to provide a system which features a wearable device or set of devices featuring one or more IMU's along with modules of code which enable detection and inference of an end user's movements (e.g., measure duration, posture, and repeatability) and allow for comparison with and competition against other users of the system. Additionally, the use of a heart rate sensor will allow the calculation of calories burned, etc. All data from the device(s) will be both exportable and transmittable in real-time to a connected computer, mobile phone, or compatible peripheral allowing for a user's dance moves to be tracked and reported accurately.

An advantage of the present invention is its use of more than one IMU's to track movement which allows for the precise tracking of individual body part movement. Twerking, for instance, is a dance which has become popular in recent years. It is an excellent work out but features movement of only very specific portions of the body (e.g., buttocks and hips). Accordingly, there is a need to track the movement of these specific areas while the rest of the body moves, by comparison, very little. Such movement is not currently easily detected by motion trackers such as the Fitbit, etc. and thus there is a need for a specific, targeted body movement tracking system.

Another advantage of the present system is seen when a trainer wants to demonstrate something to a pupil in certain manner and desires to quantify technique effectiveness. The present system provides an online portal that allows for instructors to rate, store and analyze data from the sensor. This portal can also store data collected about users over time and monitored automatically by the system to prevent excess fatigue and potential injury. The data could also be used in an aggregate form by way of an automated and digital personal trainers currently integrated with popular digital assistants such as Cortana from Microsoft and SIRI from Apple.

Yet another advantage of the present system is its ability to automatically detect what type of dance or motion an end use is performing. Using sets of data provided about various types of a dancing as a base line (e.g., Twerking, Zumba®, CIZE®, other forms of aerobic dance exercise, etc.) the present system can discern what dance(s) an end user is performing and then track and update its monitoring data based off data collected for a given user and aggregated data collected by all instances of the system to better assess such dance moves. The sensor devices are also modular in design, allowing them to be affixed to closing, mounted as jewelry in pendant form, or attached directly to the body via clip as a user changes from one dance to another, etc.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an overview diagram of a body motion tracking system.

FIG. 2 is a decision tree of the module of code which determines if the body movement threshold has been crossed.

FIG. 3 is a decision tree of the system's 100 movement classifying module of code.

FIG. 4 is an illustration of a dual motion tracking device harness.

FIG. 5 is an illustration of a smock with an imbedded motion tracking device.

FIG. 6 is an illustration of a pair of shorts with an imbedded motion tracking device.

### DETAILED DESCRIPTION OF THE INVENTION

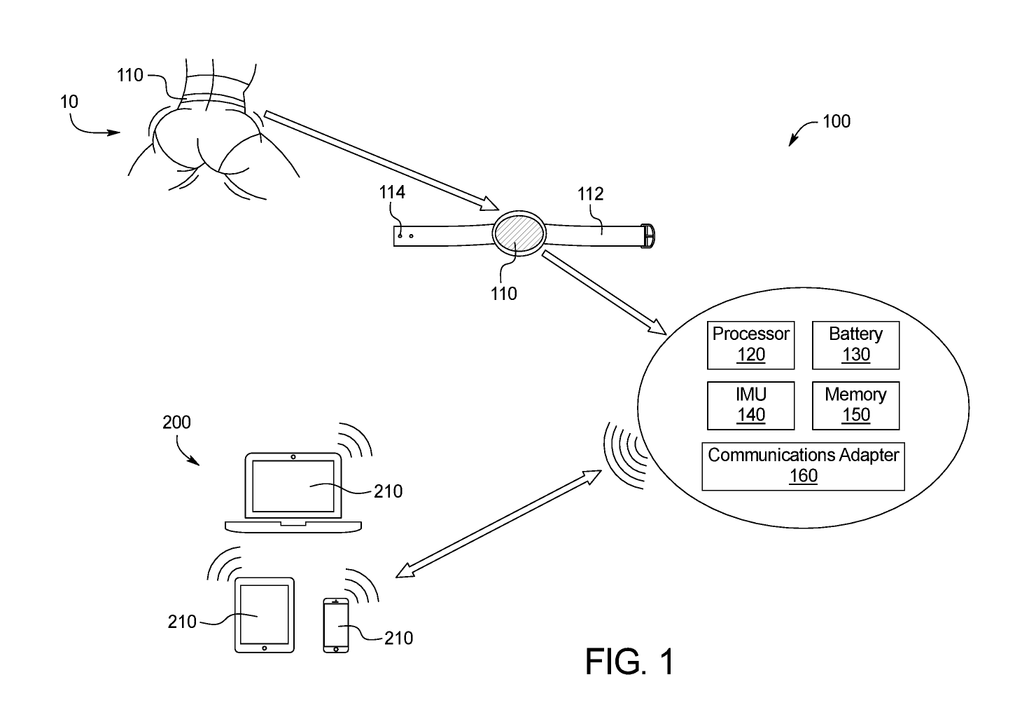

FIG. 1 is an overview diagram of a body motion tracking system 100. In the embodiment shown in this figure, an end user 10 wears a motion tracking device 110 attached to a belt 112. The belt 112 may be adjustable and feature a closure 114 (e.g., Snap Buttons, Hook and Loop Fasteners, etc.) which can be adjusted as needed to secure the belt 112 around a waist of the user 10. The belt 112 may have the motion tracking device 110 affixed to it permanently or temporarily (e.g., clipped on). The device 110 itself features a processor 120, a battery 130, an IMU(s) 140, a memory 150, and a communications adapter 160.

The device 110 also features a module of code stored in the memory 150 (and executed by the processor 120) which monitors data collected by the IMUS 140 of the given device 110 and holds the device 110 in a low power mode until the IMUs 140 detect significant body movement for a monitored body area (e.g., the buttocks) of an end user 10. The low power mode preserves the battery's 130 charge by running only basic tasks on the device 110 until more functions are needed. The threshold for what constitutes significant body movement may be determined by the module of code automatically based off body movement data collected for other users of the system 100 and refined over time using data collected by the device 110 to set the movement threshold. Once the threshold is crossed (e.g., end user 10 is twerking, etc.) the processor of the device 110 switches from low power mode to using all components of the device 110 needed to monitor the dance moves of the user.

Once in monitoring mode, the device 110 will use as much power as needed to monitor and collected data about movement of the end user's 10 body and transmit this data using the communications adapter(s) 160. The device 110 utilizes the communication adapter(s) 160 (e.g., Bluetooth, Wi-Fi, ZigBee, etc.) to communicate with one or more computing devices 200. These computing devices 200 may be any type of smartphone, personal computer, tablet, or other mobile device. The data transmitted from the tracking device (or devices) 110 monitoring a given end user 10 may collate and organize the data before transmission to aid in analysis by the system 100.

Once the movement data is sent to a computing device 200, a standalone or integrated application 210 may receive and analyze the data. Such analysis may involve identifying the type of movement or dance being carried out by a user 10 based off the type of movement data collected automatically and then also tracking details about how the given user moves or dances.

For instance, in the example shown, the system's 100 motion tracking device 110 affixed to a belt 112 will sit in close proximity to an end user's 10 hips and buttocks. The movement threshold for such a device is programmed to not track movement data for mundane or irrelevant movement (e.g., walking, running, swimming, etc.) but is triggered by specific, predefined movement data which corresponds to twerking, Zumba®, or another type of dance programmed to be identified by the system 100. Specifically, the IMU(s) 140 may include a gyroscope, an accelerometer, magnetometer and other sensors. Each of the gyroscope, accelerometer, and other IMUs measures a unique aspect of the body movement and collectively provide a broad array of data that comprise the predefined movement data for each dance recognized by the system 100. In some embodiments, a single device 110 may include a plurality of IMUs 140, while in other devices, the system 100 may include a first device 110A having a first IMU 140A and a second device 110B having a second IMU 140B. Once a user starts moving in accordance with the predefined movement data, the device 110 tracks information regarding the dance session of the user 10 including data about speed, rhythm, duration, and other measurable aspects of the movement in the buttocks area. Such data is then transmitted wirelessly from the device 110 to a computing device 200 of the user 10 such as a smartphone, a smartwatch, etc., running the system's 100 application which can report the data collected to end user's in the form of easy to read reports as well as comparison with past personal bests and a ranking board of dance data collected from other users 10 utilizing other instances of the system 100.

The data collected and monitored by the system 100 may also be used to generate alerts (e.g., a user 10 has been twerking too long or too fast) and may be combined with data from other biometric sensors (e.g., heart rate monitor) to provide even greater detail about a given dance or movement. For example, with the inclusion of heart rate data along with movement data, an accurate calculation of calories burned per twerk session can be generated by the system 100.

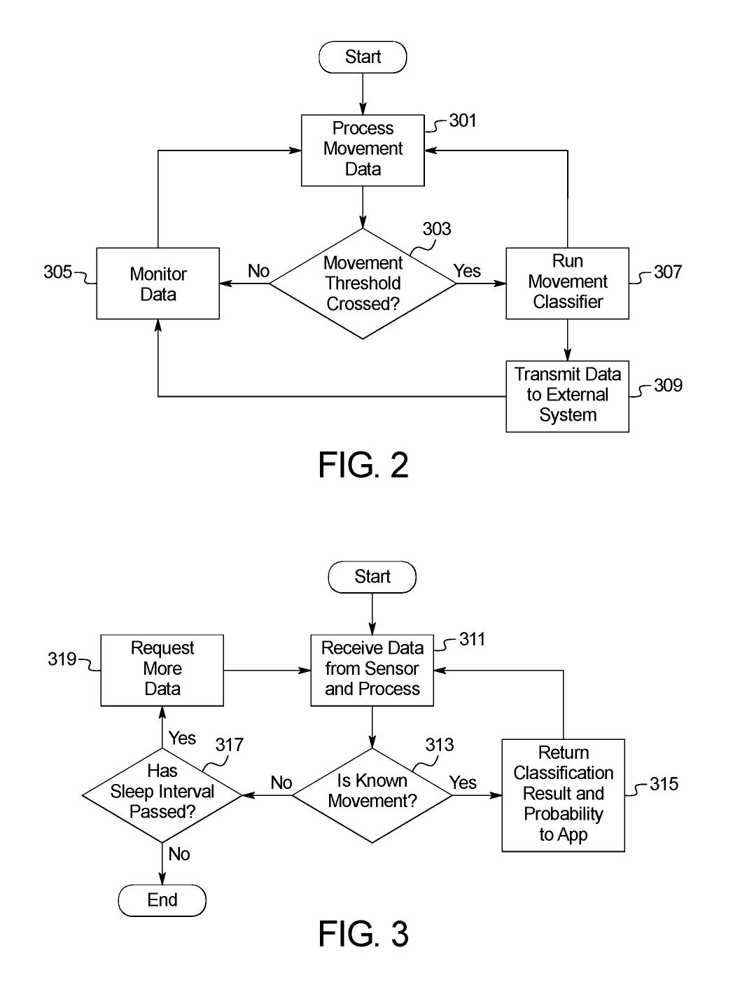

FIG. 2 is a decision tree of the module of code which determines if a body movement threshold has been crossed. As shown in FIG. 2, at a first step 301, any movement data detected by an IMU 140 of the system 100 is processed by the system 100. At the next step 303, the system 100 determines if the movement threshold has been crossed. If not, the system 100, at step 305, does not record the movement data and continues to monitor for movements which do cross the threshold. If the threshold is crossed, then the system 100, at step 307, does record that data and runs a movement classifying module of code (step 309, see FIG. 3).

FIG. 3 is a decision tree of the system's 100 movement classifying module of code. As shown in FIG. 3, at a first step 311, movement data which is significant enough to trigger the predefined movement threshold (shown in FIG. 2) is received and processed by a processor (the processor may be the processor 120 of the motion tracking device 110 shown in FIG. 1). Once processed, the system 100 determines, at step 313, if the movement is known or unknown. Known movements are identified by the system 100 as such based off predefined, distinct characteristics for a given dance or movement (e.g., twerking). If such known movement is detected, the system 100, at step 315, will transmit this data to the system's 100 application for further analysis and/or reporting. If the movement is not known by the system 100, it will determine if the movement has stopped (e.g., if the sleep interval has passed; step 317) and then request more data from the IMU(s) 140 (step 319) and repeat steps 311-319 until the movement has been identified or has ceased.

An example of how the system 100 would carry out the decision trees discussed above is when an end user 10 is preparing to twerk. Typically, twerking is part of a greater overall dance which involves movement of the whole body. As a user 10 moves their arms and legs, the tracker(s) 110 they are wearing will detect such movement, but such movement will not trigger the system 100 to begin collecting, classifying, and reporting this movement data because the system's 100 movement threshold is not crossed by the arm and leg movement. Alternatively, once a user begins moving their hips and buttocks, the threshold is surpassed and the system 100 will begin collecting and reporting data regarding these movements. If the data about hip and buttocks movements collected by the system 100 match up with predefined sets of data which define for the system 100 what constitutes “twerking movement” the system 100 will identify it as such and report it. Additionally, if the system 100 does not recognize the hip and buttocks movement being detected, it can continue to monitor the movement until it matches up the data collected with an alternative matching data set (e.g., Zumba® instead of twerking). Such matching may be done in real time, with the system 100 referencing new movement data sets online if it is unable to identify the movement. Practically, this would enable the system 100 to identify, track, and report on, for example, the newest internet dance craze without the need for an end user 10 to do anything but dance.

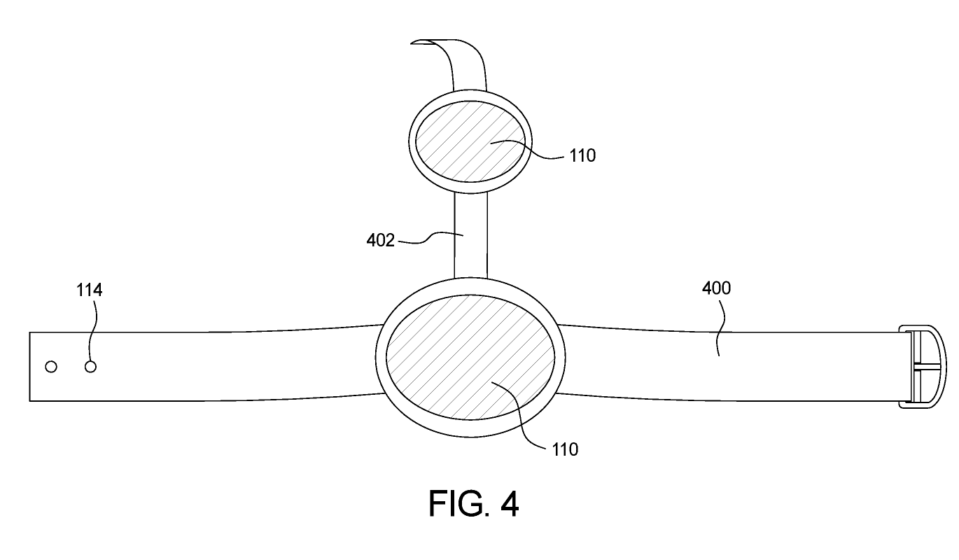

FIG. 4 is an illustration of a dual motion tracking device 110 harness 400. As shown in FIG. 2, a first motion tracking device 110A shown in FIG. 1 may work in unison with a separate, second motion tracking device 110B affixed to another portion of the end user's 10 body. Like the belt 112 shown in FIG. 1, this embodiment features an adjustable closure 114 and a tether 402 which connects the first and second tracking devices 110A, 110B together. The benefit in using more the one IMU 140 (in this embodiment at least two are used) is that it provides additional data points for dance/movement identification. This helps prevent false positives in classifying a dance move.

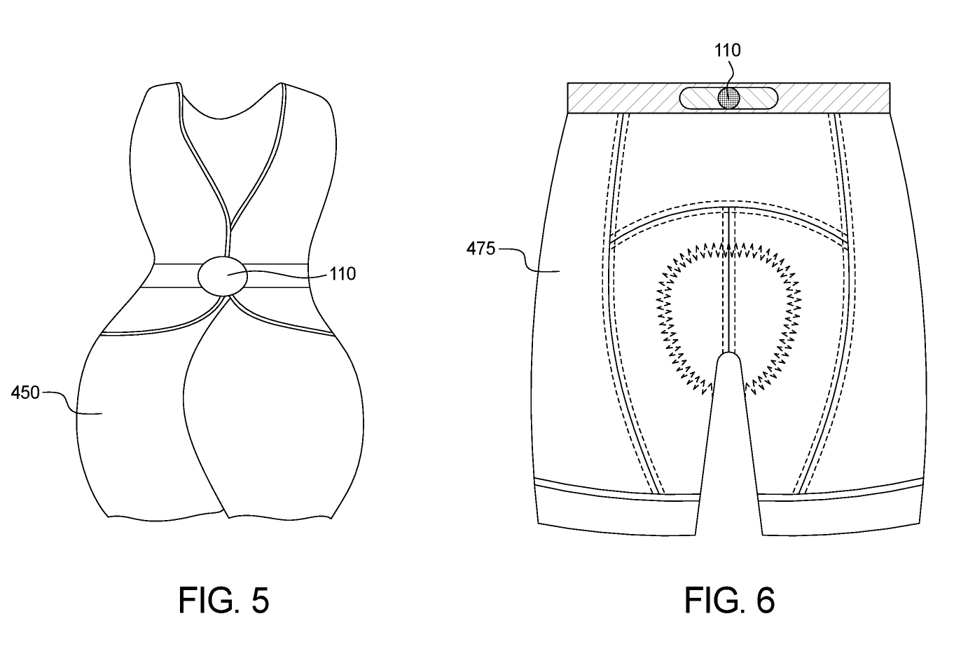

FIG. 5 is an illustration of a smock 450 with an imbedded motion tracking device 110. As shown in FIG. 5, the motion tracking device 110 of the system 100 may be intergraded or embedded into clothing. In this case, the device 110 acts as a closure for the smock 450.

FIG. 6 is an illustration of a pair of shorts 475 with an imbedded motion tracking device 110. As shown in FIG. 6, the motion tracking device 110 of the system 100 may be intergraded or embedded into clothing. In this case, the device 110 sits in the waist band of the shorts 475.

It should be noted that in the embodiments shown in FIG. 5-6 only the tracking device 110 is imbedded within the clothing shown, but other system 100 functions may be incorporated into these garments (e.g., smart clothing with LED displays, heart rate monitors, etc.).

It should also be noted that various changes and modifications to the presently preferred embodiments described herein will be apparent to those skilled in the art. Such changes and modifications may be made without departing from the spirit and scope of the present invention and without diminishing its attendant advantages.

We claim:

1. A body movement tracking system in communication with a computing device, comprising:
an inertial measurement unit;
a processor; and
a communication adapter; and
a memory coupled to the processor configured to store program instructions that, when executed by the processor, cause the processor to:
capture data corresponding to speed and rhythm of a dance;
compare an inertial measurement of the data with an initiation threshold; and
if the inertial measurement exceeds the initiation threshold, automatically initiate transmission of the at least one data point through the communications adapter to the computing device.

2. The body movement tracking system of claim 1, wherein the inertial measurement corresponds to an inertial measurement created by a specific body motion of the dance.

3. The body movement tracking system of claim 2, wherein the specific body motion is an aerobic dance exercise.

4. The body movement tracking system of claim 3, wherein the specific body motion is twerking.

5. The body movement tracking system of claim 1, further comprising a plurality of inertial movement units.

6. The body movement tracking system of claim 5, wherein the plurality of inertial movement units includes an accelerometer and a gyroscope.

7. The body movement tracking system of claim 1, wherein the data transmitted by the system is received by a computing device application on the computing device.

8. The body movement tracking system of claim 1, further comprising a database including a set of body movement data in communication with the processor, and wherein the memory is further configured to store program instructions that, when executed by the processor, cause the processor to automatically identify the dance by comparing the data to the set of body movement data.

9. The body movement tracking system of claim 8, wherein the specific type of body movement identified is aerobic dance exercise.

10. The body movement tracking system of claim 9, wherein the specific type of body movement identified is twerking.

11. The body movement tracking system of claim 1, wherein the data transmitted by the system is stored in a user profile.

12. The body movement tracking system of claim 11, wherein the data includes a first data point and a second data point, and wherein the first data point stored in the user profile is used to generate an alert message when a second data point exceeds a predefined threshold.
